(19) United States
(12) Patent Application Publication
(10) Pub. No.: US 2024/0221363 A1
(43) Pub. Date: Jul. 4, 2024

(54) FEATURE FUSION FOR INPUT PICTURE DATA PREPROCESSING FOR LEARNING MODEL

(71) Applicant: Alibaba (China) Co., Ltd., Hangzhou (CN)

(72) Inventors: Binzhe Li, Beijing (CN); Shiqi Wang, Hong Kong (CN); Yan Ye, San Diego, CA (US); Shurun Wang, Beijing (CN)

(21) Appl. No.: 18/400,954

(22) Filed: Dec. 29, 2023

Related U.S. Application Data
(60) Provisional application No. 63/436,817, filed on Jan. 3, 2023.
(60) Provisional application No. 63/492,205, filed on Mar. 24, 2023.

(51) Int. Cl. G06V 10/77; G06V 10/26; G06V 10/34; G06V 10/80; G06V 10/82; G06V 20/40

(52) U.S. Cl. CPC G06V 10/7715; G06V 10/273; G06V 10/34; G06V 10/806; G06V 10/82; G06V 20/46; G06V 20/49

(57) ABSTRACT

Methods and systems implement input picture data preprocessing for a learning model by picture data blurring based on deep features. Intermediate features are extracted from convolutional layers of a preprocessing model, and each set of intermediate features are fused to yield a fused feature map, and enlarged to input picture size. Based on the fused feature map, the preprocessing model can configure one or more processors of an input preprocessing computing system to, in performing blurring preprocessing computations, emphasize picture data having larger corresponding characteristic values, and deemphasize other picture data.

### RELATED APPLICATIONS

This application claims the benefit of U.S. Patent Application No. 63/436,817, entitled “FEATURE FUSION FOR INPUT PICTURE DATA PREPROCESSING FOR LEARNING MODEL” and filed Jan. 3, 2023, and claims the benefit of U.S. Patent Application No. 63/492,205, entitled “FEATURE FUSION FOR INPUT PICTURE DATA PREPROCESSING FOR LEARNING MODEL” and filed Mar. 24, 2023, each of which is expressly incorporated herein by reference in its entirety.

### BACKGROUND

Present image coding techniques, such as H.264/AVC (Advanced Video Coding) and H.265/HEVC (High Efficiency Video Coding) and Versatile Video Coding (“VVC”), are primarily based in lossy compression, based on a framework including transform coding, quantization, and entropy coding. For many years, lossy compression has achieved compression ratios which are suited to image capture and image storage at limited scales. The main task of such existing codecs is to seek better reconstructed signal quality with limited bitrate constraint.

Based on machine learning, end-to-end image compression techniques have been developed, wherein parameters of a non-linear transformation are learned by training a deep neural network on image and video datasets, where the non-linear transformation configures a computing system to map an input picture into a latent representation thereof in a latent space. Entropy coding techniques are then applied to a latent representation of the image, improving computational efficiency.

Furthermore, due to the emergence of fields such as computer vision and machine vision, computer systems are increasingly configured to capture and store images at much larger scales. Machine learning and deep learning configure computer systems to perform new tasks, powered by massive-scale image and video datasets, and so machine learning image and video datasets also rely on image compression to improve efficiency of data storage.

However, images and videos to be input into machine learning models do not have the same signal quality requirements emphasized by existing lossy compression codecs, and nor do they have the same optimization requirements emphasized by end-to-end image compression techniques. There is a need for techniques beyond both conventional lossy compression codecs and end-to-end image compression techniques to achieve compression and computational efficiency while prioritizing image data used by machine learning models for computations.

### BRIEF DESCRIPTION OF THE DRAWINGS

The detailed description is set forth with reference to the accompanying figures. In the figures, the left-most digit(s) of a reference number identifies the figure in which the reference number first appears. The use of the same reference numbers in different figures indicates similar or identical items or features.

FIG. 1 illustrates a flowchart of an image compression process as performed by one or more processors of a computing system configured by a VVC-standard encoder, and one or more processors of a computing system configured by a VVC-standard decoder.

FIG. 2 illustrates a flowchart of an input preprocess outputting to an image compression process of FIG. 1.

FIG. 3 illustrates a mask-based picture data removal and blurring preprocessing technique.

FIG. 4 illustrates a flowchart of intermediate feature extraction and fusion from convolutional layers of a preprocessing model according to example embodiments of the present disclosure.

FIG. 5 illustrates a feature-based blurring preprocessing technique according to example embodiments of the present disclosure.

FIG. 6 illustrates a union of masks across a sequence of pictures.

FIG. 7 illustrates an example input preprocessing computing system for implementing the processes and methods described herein for implementing intermediate feature fusion extracted from convolutional layers of a preprocessing model.

FIG. 8 illustrates an example encoding and decoding computing system for implementing the processes and methods described herein for implementing a VVC-standard encoder and a VVC-standard decoder.

### DETAILED DESCRIPTION

Systems and methods discussed herein are directed to implementing data preprocessing for learning models, and more specifically performing picture preprocessing on image and video datasets for model training based on intermediate feature fusion extracted from convolutional layers of a preprocessing model.

A learning model, according to example embodiments of the present disclosure, includes at least computer-readable instructions executable by one or more processors of a computing system to perform computational tasks that include computing inputs based on values of various parameters, and outputting results. A learning model can be, for example, a layered model such as a deep neural network, which can have a fully-connected structure, can have a feedforward structure such as a convolutional neural network (CNN), can have a backpropagation structure such as a recurrent neural network (RNN), or can have other architectures suited to the computation of particular computational tasks. Computational tasks can include, for example, classification, clustering, matching, regression, and the like.

One or more processors of a computing system can further be configured to perform inference computations based on outputs of these computational tasks to yield inference results relevant to solving various problems such as recognizing entities in images and/or video; tracking movement of entities over multiple video frames; matching recognized entities in images and/or video to other images and/or video; providing annotations or transcriptions of images, video, and/or audio in real-time; and the like.

A computing system training a learning model or computing inferences based on a trained learning model can be in communication with one or more input devices configured to capture data to be input into learning models to perform computations based on the learning models, in association with various tasks, for the analysis and output of results required for the performance of those tasks. An input device can store captured data on a non-transient computer-readable medium, which can be a component of an input processing computing system. An input device can itself be a component of an input processing computing system, or can be a device external to the input processing computing system. The input processing computing system can be a same computing system training a learning model or computing inferences based on a trained learning model, or can be a different computing system. Where these are different computing systems, they can intercommunicate by suitable connections, such as wired or wireless network connections.

An input device can be in communication with one or more processors of an input processing computing system by a data bus connection, a wired network connection, a wireless network connection, and the like. The input device can be configured to transmit captured data to an input processing computing system, which is configured to write the captured data to a storage device, the storage device including one or more non-transient computer-readable media.

An input device can be a video camera which collects still images, video, and other types of picture data. By way of example, such a video camera can be a standalone camera; can be a peripheral device connected to a computing system; can be one among any number of cameras integrated into electronic equipment, mechanical equipment, motorized vehicles, and such electronic systems having one or more processors and computing storage devices integrated; and can be configured in communication with computing systems in any other suitable fashion.

Whether a computing system is training a learning model or computing inferences based on a trained learning model, it can be configured to perform computations based on the learning model upon captured picture data. Due to the very large file sizes of picture datasets used in deep learning, storage of picture datasets can incur substantial storage space, and loading and computation of picture datasets can incur substantial computational overhead.

Moreover, according to computing architectures where training a learning model or computing inferences based on a trained learning model are performed by cloud computing systems, massive quantities of locally captured and stored data at input can result in intolerable degrees of latency if delivered to a cloud computing system over network connections. Additionally, images in a raw, uncompressed format are highly inefficient for machine learning computation due to containing many times more data, often superfluous for machine learning training and inference purposes, than compressed images. Consequently, it is desirable to compress images captured at input devices prior to the use of such images in training and inference datasets.

General-purpose, non-machine-learning oriented image compression technologies are the by-default solutions in video communication, embodied by video coding standards such as High Efficiency Video Coding (“HEVC”) and Versatile Video Coding (“VVC”). In these standards, hybrid coding framework is adopted by dividing the frames into variable-size or fixed-size blocks. Additionally, end-to-end image compression has developed as an alternative, wherein pictures are transformed into latent representations thereof based on trained deep neural networks, which are also aimed at outputting perceptually meaningful representations.

Ballé et al. proposed an end-to-end image compression framework using generalized divisive normalization (“GDN”), and the entire framework is optimized with rate-distortion optimization (“RDO”). Ballé et al. also proposed the concept of a hyperprior which captures spatial dependencies in a latent representation. Cui et al. proposed a new autoencoder called Gained Variable Autoencoder (“G-VAE”) based on continuous rate control, wherein a pair of gain units are incorporated into the end-to-end image compression framework, leading to continuous variable rate compression without increasing network parameter and computational cost. Choi et al. proposed a new variable rate image compression framework and conditional automatic encoder, where the structure of conditional fluctuation and universal quantification are employed. An end-to-end compression framework based on deep learning, Deep Video Compression framework (“DVC”), and Multiple frames prediction for Learned Video Compression (“M-LVC”), have also been developed.

Known proposals for machine vision-oriented image coding include visual signal compression and compact feature representation. For visual signal compression, Zhang et al. proposed a learned image compression (“LIC”) framework and proposed a multi-scale progressive (“MSP”) probability model for lossy image compression, based on spatial-wise and channel-wise correlation of latent representations of pictures.

Feature compression is hindered by the following factors: models are usually adjusted for specific tasks, and top-level features are very specific to tasks and difficult to promote. Chen et al. proposed feature compression of the intermediate layer, wherein intermediate layer features are compressed and transmitted instead of the original video or top layer features. End-to-end learning usually enables deep features to have a larger receptive field and more specific tasks. Therefore, compared with the depth features, the features from the shallow layer generally contain more information.

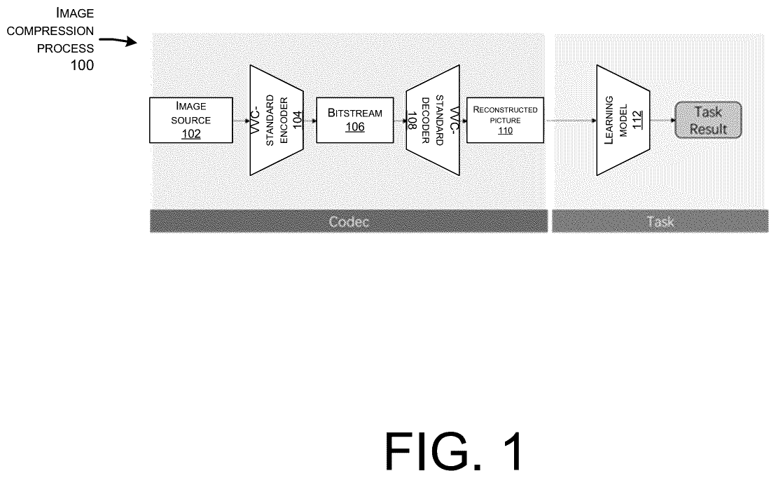

FIG. 1 illustrates a flowchart of an image compression process 100 as performed by one or more processors of a computing system configured by an encoder, and one or more processors of a computing system configured by a decoder. The image compression process 100 encompasses at least general-purpose, non-machine-learning oriented image compression techniques and machine vision-oriented image coding as described above.

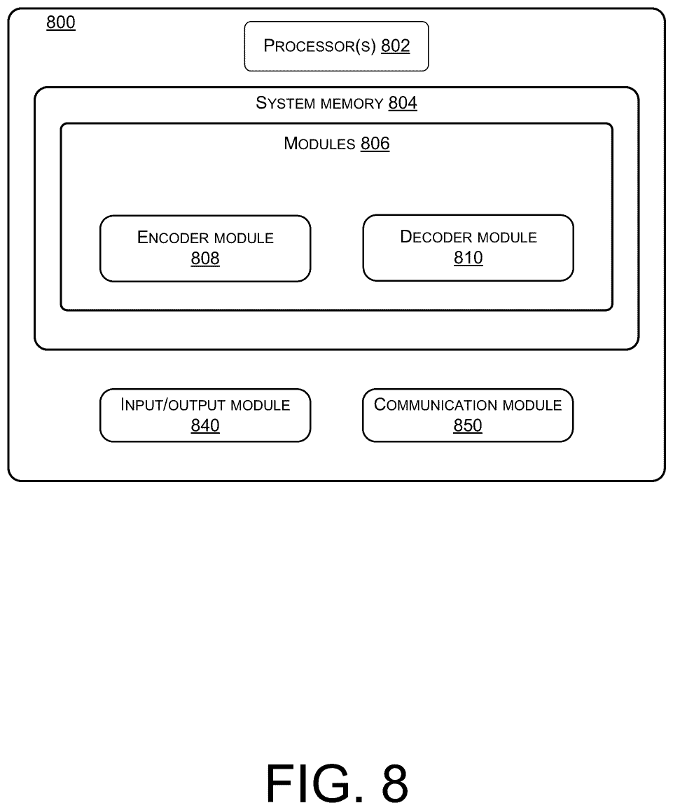

In accordance with the VVC video coding standard (the “VVC standard”) and such general-purpose image compression techniques as described therein, a computing system includes at least one or more processors and a computer-readable storage medium communicatively coupled to the one or more processors. The computer-readable storage medium is a non-transient or non-transitory computer-readable storage medium, as defined subsequently with reference to FIG. 8, storing computer-readable instructions. At least some computer-readable instructions stored on a computer-readable storage medium are executable by one or more processors of a computing system to configure the one or more processors to perform associated operations of the computer-readable instructions, including at least operations of an encoder as described by the VVC standard, and operations of a decoder as described by the VVC standard. Some of these encoder operations and decoder operations according to the VVC standard are subsequently described in further detail, though these subsequent descriptions should not be understood as exhaustive of encoder operations and decoder operations according to the VVC standard. Subsequently, a “VVC-standard encoder” and a “VVC-standard decoder” shall describe the respective computer-readable instructions stored on a computer-readable storage medium which configure one or more processors to perform these respective operations (which can be called, by way of example, “reference implementations” of an encoder or a decoder).

Moreover, according to example embodiments of the present disclosure, a VVC-standard encoder and a VVC-standard decoder further include computer-readable instructions stored on a computer-readable storage medium which are executable by one or more processors of a computing system to configure the one or more processors to perform operations not specified by the VVC standard. A VVC-standard encoder should not be understood as limited to operations of a reference implementation of an encoder, but including further computer-readable instructions configuring one or more processors of a computing system to perform further operations as described herein. A VVC-standard decoder should not be understood as limited to operations of a reference implementation of a decoder, but including further computer-readable instructions configuring one or more processors of a computing system to perform further operations as described herein.

In an encoding process, a VVC-standard encoder 104 configures one or more processors of a computing system to receive, as input, one or more input pictures from an image source 102. By way of example, a VVC-standard encoder 104 encodes a picture (a picture being encoded being called a “current picture,” as distinguished from any other picture received from an image source 102) by configuring one or more processors of a computing system to partition the original picture into units and subunits according to a partitioning structure. Furthermore, a VVC-standard encoder 104 encodes a picture by configuring one or more processors of a computing system to perform motion prediction upon blocks of a current picture.

After performing various computations upon blocks of the current picture, a VVC-standard encoder 104 configures one or more processors of a computing system to output a coded picture, made up of coded blocks from an entropy coder. The coded picture is output to a transmission buffer, where it is ultimately packed into a bitstream 106 for output from the VVC-standard encoder 104. The bitstream 106 is written by one or more processors of a computing system to a non-transient or non-transitory computer-readable storage medium of the computing system, for transmission.

A VVC-standard decoder 108 configures one or more processors of a computing system to receive, as input, one or more coded pictures from a bitstream 106. The VVC-standard decoder 108 configures one or more processors of a computing system to perform intra prediction using prediction information specified in the coding parameter sets, and configures one or more processors of a computing system to perform motion compensated prediction using a reference picture from a decoded picture buffer. A prediction signal is yielded.

After performing various computations upon a prediction signal, a VVC-standard decoder 108 configures one or more processors of a computing system to output a reconstructed picture 110 to an input layer of a learning model 112 for training and/or inference.

Furthermore, both standard image compression codecs and end-to-end, learning-based compression proposals can further benefit from preprocessing techniques, wherein one or more processors of a computing system are configured to compute raw picture data before the raw picture data is compressed.

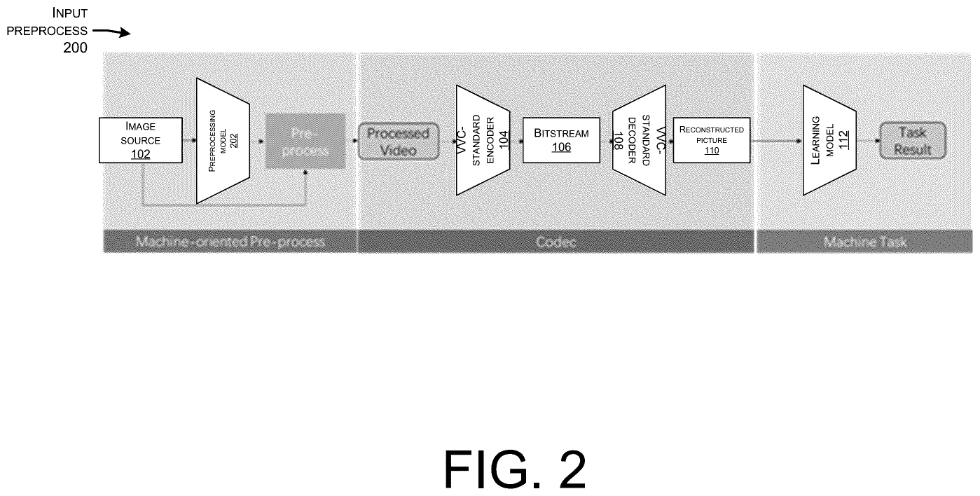

FIG. 2 illustrates a flowchart of an input preprocess 200 outputting to an image compression process 100 of FIG. 1. Once again, the image compression process 100 encompasses at least general-purpose, non-machine-learning oriented image compression techniques and machine vision-oriented image coding as described above.

In an input preprocess 200, a preprocessing model 202 configures one or more processors of an input processing computing system (such as those described above) to receive input picture data from an image source 102. The preprocessing model 202 configures one or more processors performs various preprocessing computations upon the input picture data, outputting processed picture data, which remains uncompressed, to one or more processors of a same computing system or a different computing system configured by a VVC-standard encoder 104.

Input picture data may have been captured by an input device in a raw image format. The input device may be, for example, a video camera such as a standalone camera, a peripheral device, a camera integrated into another electronic system, and the like as described above. The input device can capture picture data making up an image dataset in the form of still images or video.

Input devices can be connected by a data bus connection, optical data connection, or other connection suitable for transmission of images with an input processing computing system may be connected by a wired or wireless network connection with an input processing computing system. For example, an input processing computing system can be a personal computing system, a cluster of computing systems, a server of a cloud computing system such as an edge server, an embedded computing system of a smart device such as a vehicle or appliance, and the like.

By way of example, a preprocessing model 202 can configure one or more processors of an input processing computing system as follows. Wang et al. proposed a preprocessing technique wherein, by segmentation, a mask of important objects in picture data (an “object mask”) is derived, followed by removing part of the background according to the object mask, and blurring the rest of the background. By such a technique, picture data of less importance is deemphasized by removal or blurring.

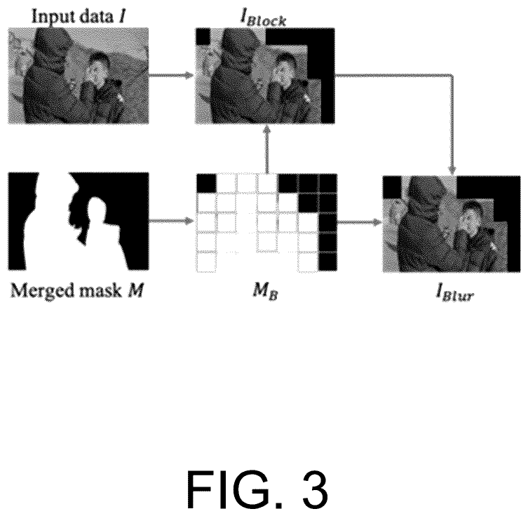

FIG. 3 illustrates a mask-based picture data removal and blurring preprocessing technique. A merged mask M is derived by segmentation as described above. The merged mask M segments picture data into at least an object segment (illustrated in white in FIG. 3) and a background segment (illustrated in black in FIG. 3), matching the actual contour of objects depicted in picture data as much as possible.

However, if M is directly used to perform picture data removal and picture data blurring computations, it could result in over-processing of regions immediately around the objects. In order to improve picture data removal and picture data blurring to achieve better discrimination for machine vision tasks, a block-based blurring preprocessing operation is further proposed to preserve the visual information around the objects/instances.

By way of example, a sliding window sₙ of size n×n pixels is applied to the input picture data I and the merged mask M, where n is determined based on the resolution of the input picture data I. When there is intersection between the sliding window sₙ and the merged mask M, the merged mask is modified to exclude each pixel of the sliding window from the masked background, preserving samples of the input picture data I at those pixels. The modified block-based mask is denoted as M_{B} and block-based masked input picture data is obtained by point-wise multiplication between M_{B} and I, denoted as I_{Block}.

Furthermore, while blurring can improve the smoothness of the input data and consequently make the blurred signal easier to compress, over-blurring of object regions can lead to degraded discrimination among different objects. Over-blurred picture data input can, in turn, lead to poorer performance of inference computations based on a learning model. To improve tradeoffs between representation expanse and machine performance, blurring-based preprocessing is further proposed to blur the non-object regions. A Gaussian blurring transformation is performed upon the block-based masked input picture data. The output of the Gaussian blurring preprocess I_{Blur} is formulated as I_{blur}=(M_{B}−M)(G_{k,s}*I)+MI, where I is the input picture data, G_{k,s} is the Gaussian filter with kernel size k and standard deviation s, and * denotes the convolutional operation.

Despite these proposals, input picture data preprocessing based on picture data blurring still suffers from limitations. Picture data blurring computations can configure one or more processors of a computing system to perform computations based on the same parameters for whole background regions of all visual data. This kind of blurring computation cannot be adaptive to diverse visual content. Depending on problems to be solved by inference results, inference computations based on a learning model may depend on part, but not all, of the background in picture data, meaning that not all parts of the background should be equally deemphasized by preprocessing.

Consequently, example embodiments of the present disclosure provide input picture data preprocessing for a learning model by picture data blurring based on deep features. According to example embodiments of the present disclosure, intermediate features are extracted from convolutional layers of a preprocessing model, and each set of intermediate features are fused to yield a fused feature map, and enlarged to input picture size. Based on the fused feature map, the preprocessing model can configure one or more processors of an input preprocessing computing system to, in performing blurring preprocessing computations, emphasize picture data having larger corresponding characteristic values, and deemphasize other picture data.

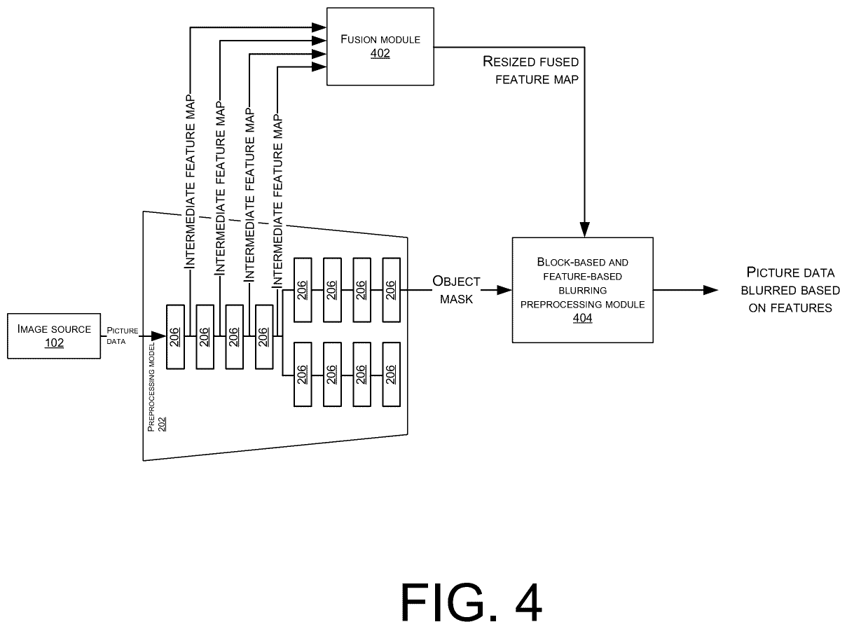

FIG. 4 illustrates a flowchart of intermediate feature extraction and fusion from convolutional layers of a preprocessing model according to example embodiments of the present disclosure. As illustrated herein, input picture data from an image source 102 is computed by one or more processors of an input preprocessing computing system configured by a preprocessing model 202, and an object mask derived from segmentation of the input picture data is output by the one or more processors.

The preprocessing model 202 can be a learning model trained to configure one or more processors of an input preprocessing computing system to perform segmentation computations upon input picture data, such as the Mask R-CNN learning model. Segmentation refers to partitioning input picture data into some number of differently-labeled segments, segments having boundaries therebetween. Each segment may convey different semantic meaning from at least some other segment. Input picture data may be partitioned based on aspects thereof such as similarities between picture data samples, differences between picture data samples, boundaries among picture data samples, and the like, as well as distinguishing foreground samples from background samples. The segmentation of objects among picture data samples should be understood as emphasizing the segmented samples over the background samples, and deemphasizing the background samples.

The preprocessing model 202 includes a number of convolutional layers 206. Each convolutional layer 206 receives picture data from a previous layer, and performs a convolution upon the picture data, yielding a feature map from the picture data. A feature map is yielded by applying a filter to the picture data, outputting a number of channels for the purpose of matrix operations which perform convolution upon the picture data. By way of example, according to the Mask R-CNN learning model, the number of convolutional layers 206 can be arranged according to a feature pyramid network (“FPN”).

At each convolutional layer 206 of the preprocessing model 202, a strided convolution and/or a pooling convolution can be performed upon the picture data. Such convolutions down-sample the picture data, reducing size and resolution of the picture data. Each such convolution yields intermediate features, which can be different from intermediate features yielded by a different convolution of a different convolutional layer 206. Thus, features extracted from a convolution performed upon picture data can have smaller size and smaller resolution than the input picture data; features extracted from different convolutions can have different sizes and resolutions; and features extracted from different convolutions can have different numbers of channels.

The preprocessing model 202 can branch into more than one stack of convolutional layers 206, where at least one branch of the preprocessing model 202 configures one or more processors of the input preprocessing computing system to output an object mask. The object mask includes one or more segments which distinguish foreground objects of picture data from background of the picture data.

Furthermore, according to example embodiments of the present disclosure, a fusion module 402 stored on a non-transient or non-transitory computer-readable storage medium of the input preprocessing computing system can configure one or more processors of the input preprocessing computing system to receive intermediate feature maps F₁, F₂, . . . , F_{N} output by N different convolutional layers 206 prior to the outputs of one or more branches of the preprocessing model 202. The fusion module 402 further configures the one or more processors to fuse intermediate feature map F₁, F₂, . . . , F_{N} output by multiple convolutional layers 206 into a fused feature map F_{P}.

One or more processors of the input preprocessing computing system are configured to average the absolute value of features of different feature maps F₁, F₂, . . . F_{N} to yield a fused feature map of single-channel features, then normalize the single-channel features, and then resize the fused feature map to the same size as the input picture data, as follows:

$${F}_{P} = \frac{1}{N} {\sum }_{i = 1}^{N} \vert {F}_{i} \vert$$

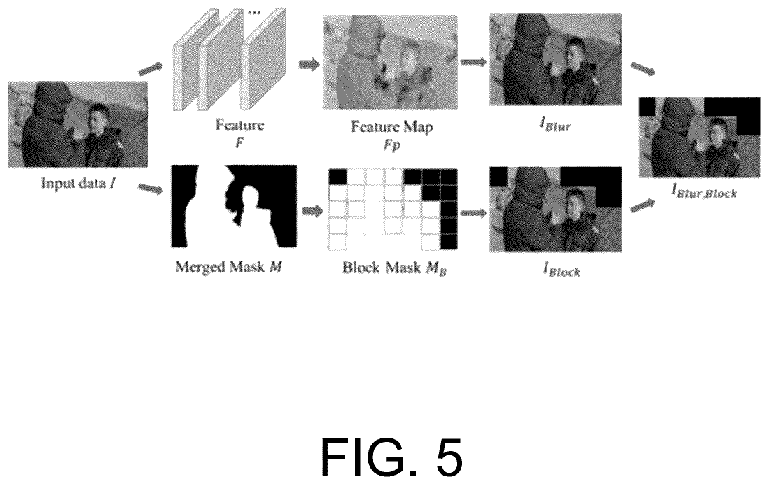

One or more processors of the input preprocessing computing system are configured to output the resized fused feature map as an input to a blurring preprocessing operation. A block-based and feature-based blurring preprocessing module 404 configures one or more processors of the input preprocessing computing system to perform mask-based picture data removal and blurring preprocessing as shall be described subsequently with reference to FIG. 5.

After feature maps F₁, F₂, . . . , F_{N} (herein denoted as F, for brevity) yield a fused feature map Fr, one or more processors of the input preprocessing computing system performs a Gaussian blur transformation upon each pixel of the input picture data I, wherein the Gaussian blur transformation takes as input a feature map value corresponding to that pixel from the fused feature map F_{P}. By way of example, the feature map value corresponding to the pixel can be computed as a standard deviation value in the Gaussian blur transformation:

$$G ( x , y ) = \frac{1}{2 {πσ}^{2}} {e}^{- \frac{{x}^{2} + {y}^{2}}{2 {σ}^{2}}}$$

where (x, y) is a coordinate of the pixel, and σ is a standard deviation value.

Additionally, the block-based and feature-based blurring preprocessing module 404 configures one or more processors of the input preprocessing computing system to perform block-based blurring preprocessing as described above with reference to FIG. 3. Thus, the one or more processors can be configured to perform a Gaussian blur transformation upon each pixel of input picture data based on a feature map value (i.e., performing feature-based, but not block-based blurring preprocessing); the one or more processors can be configured to perform a Gaussian blur transformation upon block-based masked pixels of input picture data (i.e., performing block-based, but not feature-based blurring processing); and the one or more processors can be configured to perform a Gaussian blur transformation upon block-based masked pixels of input feature data based on a feature map value (i.e., performing block-based and feature-based blurring preprocessing).

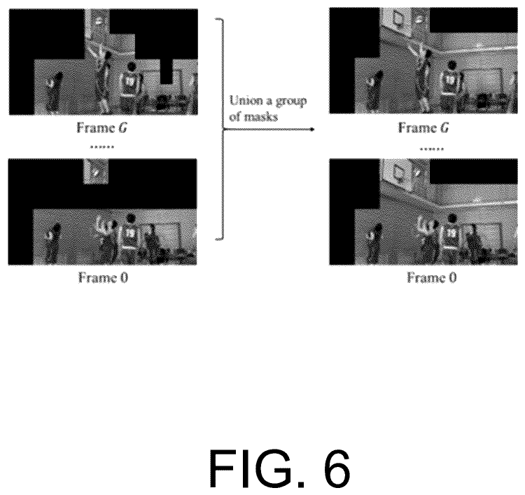

Moreover, according to example embodiments of the present disclosure, the block-based and feature-based blurring preprocessing module 404 configures one or more processors of the input preprocessing computing system to perform a union computation across modified masks of a sequence of pictures. Across a sequence of pictures of a video sequence, block-based masking can degrade visual continuity due to the appearance and disappearance of visible blocks across sequential pictures. To improve visual continuity for a sequence of pictures, one or more processors can be configured to union modified masks for all pictures of the sequence, then apply the modified masks to each picture, as illustrated in FIG. 6.

Subsequently, picture data preprocessing proceeds as previously described, but using this additional input for subsequent computations.

In various regards, example embodiments of the present disclosure can be implemented alternatively:

The preprocessing model can replace or jointly use multiple analysis networks according to different task requirements, such as other detection and segmentation methods or tracking methods.

Features can be derived from the preprocessing model by outputs other than convolutional layers. The features of different layers can be extracted and utilized. At the same time, the gradient of back propagation can also be applied for feature refinement.

Feature maps can also be derived from features through different calculation methods than fusion, such as manual design methods (maximum and average) and deep learning-based methods.

Moreover, according to example embodiments, input picture data from an image source 102 is adaptively input into one of either the preprocessing model 202 or a block-based and feature-based blurring preprocessing module 404, and segmentation is, accordingly, performed upon the input picture data, configured by either the preprocessing model 202 or the block-based preprocessing and feature-based blurring preprocessing module 404, to output an object mask. Motivated by diversity of input video data, such a preprocessing method alternatively, or in combination, performs block-based preprocessing and feature-based blurring preprocessing, so as to improve overall rate-distortion performance.

According to a preprocessing method as described herein, a block-based preprocessing and feature-based blurring preprocessing module 404 stored on a non-transient or non-transitory computer-readable storage medium of the input preprocessing computing system can configure one or more processors of the input preprocessing computing system to decide preprocessing for a video sequence based on two metrics: average object mask ratio of a video sequence, and temporal complexity of a video sequence. A preprocessing decision by the one or more processors as configured by the block-based and feature-based blurring preprocessing module 404 causes input picture data to subsequently be processed, alternatively or in combination, by preprocessing model 202 in an input preprocess 200 as described above, and/or by feature-based and block-based blurring preprocessing.

Temporal complexity is a metric of video time domain variation, which is obtained from the mean absolute difference (“MAD”) of the frames. The block-based and feature-based blurring preprocessing module 404 configures one or more processors of the input preprocessing computing system to compute temporal complexity as follows:

$$M = {\sum }_{i = 0}^{l - k} MAD ( {I}_{i} , {I}_{i + k} ) / l ,$$

where l is the number of the frames and k is the interval between the frames. Greater temporal movement in a video indicates that the video content of objects and a background is more complex across the temporal domain. To reduce computational complexity given greater complexity over time, the block-based and feature-based blurring preprocessing module 404 configures one or more processors of the input preprocessing computing system to, given temporal complexity in excess of a complexity threshold, perform feature-based and block-based blurring preprocessing in combination to remove background around one or more objects while preserving the one or more objects.

Performing feature-based and block-based blurring preprocessing in combination includes at least the following: performing segmentation upon an input picture as illustrated in FIG. 4 as described above to output an object mask, followed by performing mask-based picture data removal and blurring preprocessing as illustrated in FIG. 5 as described above, applying the object mask to the input picture, and blurring the masked picture.

Average object mask ratio of the image quantifies the average proportion of each object in the frame. To compute an average object mask ratio, the preprocessing model 202 configures one or more processors of the input preprocessing computing system to obtain the object number O(Iᵢ) and the corresponding mask ratio m(Iᵢ), then compute the average as follows:

$$K = \frac{{\sum }_{i = 0}^{l} m ( {I}_{i} )}{O ( {I}_{i} ) * l} ,$$

An object number is a number of distinct object segments in an object mask. A mask ratio is a ratio between number of pixels of one object segment and number of pixels of an entire picture, and can be derived by dividing the number of pixels of the object segment by the number of pixels of the picture.

Computations that yield overly small average object mask ratios indicate that the object occupies less of the whole frame than background, in which case a mask generated according to a preprocessing model 202 may not be completely accurate because the object is too small. Therefore, for average object mask ratios below a ratio threshold, the block-based and feature-based blurring preprocessing module 404 configures one or more processors of the input preprocessing computing system to perform block-based blurring preprocessing without performing feature-based blurring preprocessing, so as to preserve the background around the object. In this fashion, computational cost of coding is kept under control, and background preservation keeps critical information from becoming distorted.

A complexity threshold and a ratio threshold as described above can each be described as matrices Mₜₕᵣₑₛ and Kₜₕᵣₑₛ, respectively. By way of example, Mₜₕᵣₑₛ can be set to 10, and Kₜₕᵣₑₛ can be set to 7%. Furthermore, comparisons against each threshold can be performed in the below order: first, if the temporal complexity M≥Mₜₕᵣₑₛ, feature-based and block-based blurring preprocessing are performed in combination. Otherwise, if the video has small objects K≤Kₜₕᵣₑₛ, block-based blurring preprocessing is performed without performing feature-based blurring preprocessing. For other outcomes, the block-based and feature-based blurring preprocessing module 404 configures one or more processors of the input preprocessing computing system to compress the video as configured by a VVC-standard encoder and a VVC-standard decoder directly.

It should be understood that the block-based and feature-based blurring preprocessing module 404 can configure one or more processors of the input preprocessing computing system to decide preprocessing for a video sequence based on other traditional or deep learning-based metrics, such as object classes, video length and other features.

It should be understood that the block-based and feature-based blurring preprocessing module 404 can configure one or more processors of the input preprocessing computing system to perform feature-based blurring preprocessing without performing block-based blurring preprocessing as an alternative, and to alternatively or in combination perform Gaussian blur preprocessing and/or other preprocessing techniques.

It should be understood that the block-based and feature-based blurring preprocessing module 404 can configure one or more processors of the input preprocessing computing system to decide preprocessing methods in different orders, and to decide preprocessing methods based on different thresholds. By way of example, preprocessing can be decided in the following order, based on the following thresholds: first, for video sequences with large average object mask ratios, feature-based blurring preprocessing and block-based blurring preprocessing are performed in combination; otherwise, for video sequences with smaller average object mask ratio and low temporal domain complexity, block-based blurring preprocessing is performed to preserve background information; otherwise, finally, video sequences with small objects and complex time domains are not processed.

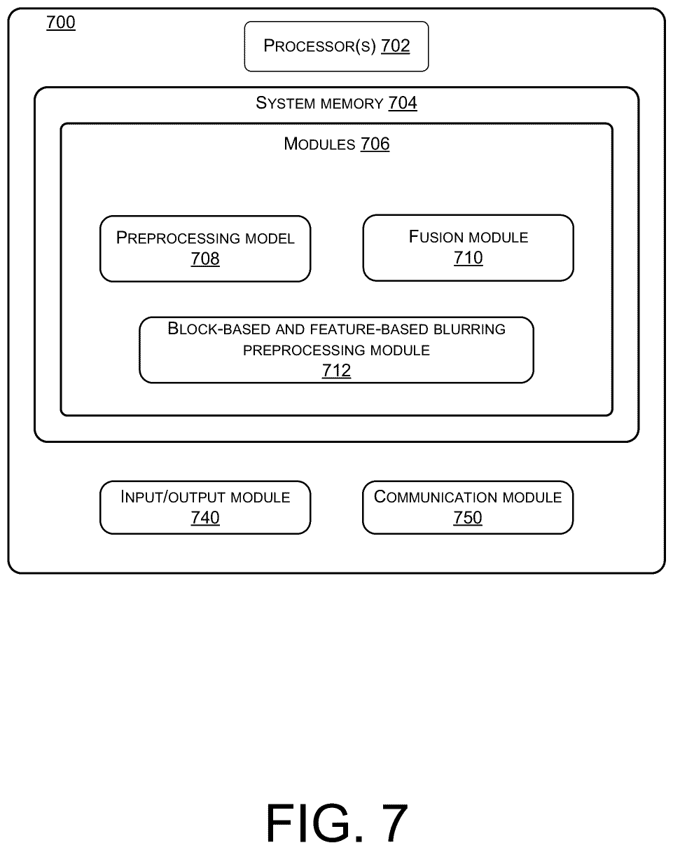

FIG. 7 illustrates an example input preprocessing computing system 700 for implementing the processes and methods described above for implementing intermediate feature fusion extracted from convolutional layers 206 of a preprocessing model 202.

The techniques and mechanisms described herein may be implemented by multiple instances of the input preprocessing computing system 700, as well as by any other computing device, system, and/or environment. The input preprocessing computing system 700 shown in FIG. 7 is only one example of a system and is not intended to suggest any limitation as to the scope of use or functionality of any computing device utilized to perform the processes and/or procedures described above. Other well-known computing devices, systems, environments and/or configurations that may be suitable for use with the embodiments include, but are not limited to, personal computers, server computers, hand-held or laptop devices, multiprocessor systems, microprocessor-based systems, set top boxes, game consoles, programmable consumer electronics, network PCs, minicomputers, mainframe computers, distributed computing environments that include any of the above systems or devices, implementations using field programmable gate arrays (“FPGAs”) and application specific integrated circuits (“ASICs”), and/or the like.

The input preprocessing computing system 700 may include one or more processors 702 and system memory 704 communicatively coupled to the processor(s) 702. The processor(s) 702 and system memory 704 may be physical or may be virtualized and/or distributed. The processor(s) 702 may execute one or more modules and/or processes to cause the processor(s) 702 to perform a variety of functions. In embodiments, the processor(s) 702 may include a central processing unit (“CPU”), a graphics processing unit (“GPU”), both CPU and GPU, or other processing units or components known in the art. Additionally, each of the processor(s) 702 may possess its own local memory, which also may store program modules, program data, and/or one or more operating systems.

Depending on the exact configuration and type of the input preprocessing computing system 700, the system memory 704 may be volatile, such as RAM, non-volatile, such as ROM, flash memory, miniature hard drive, memory card, and the like, or some combination thereof. The system memory 704 may include one or more computer-executable modules 706 that are executable by the processor(s) 702.

The modules 706 may include, but are not limited to, a preprocessing model 708, a fusion module 710, and a block-based and feature-based blurring preprocessing module 712.

The preprocessing model 708 can configure one or more processors in accordance with a preprocessing model 202 as described above.

The fusion module 710 can configure one or more processors in accordance with a fusion module 402 as described above.

The block-based and feature-based blurring preprocessing module 712 can configure one or more processors in accordance with a block-based and feature-based blurring preprocessing module 404 as described above.

The input preprocessing computing system 700 may additionally include an input/output (“I/O”) interface 740 and a communication module 750 allowing the input preprocessing computing system 700 to communicate with other systems and devices over a network. The network may include the Internet, wired media such as a wired network or direct-wired connections, and wireless media such as acoustic, radio frequency (“RF”), infrared, and other wireless media.

Some or all operations of the methods described above can be performed by execution of computer-readable instructions stored on a computer-readable storage medium, as defined below. The term “computer-readable instructions” as used in the description and claims, include routines, applications, application modules, program modules, programs, components, data structures, algorithms, and the like. Computer-readable instructions can be implemented on various system configurations, including single-processor or multiprocessor systems, minicomputers, mainframe computers, personal computers, hand-held computing devices, microprocessor-based, programmable consumer electronics, combinations thereof, and the like.

The computer-readable storage media may include volatile memory (such as random-access memory (“RAM”)) and/or non-volatile memory (such as read-only memory (“ROM”), flash memory, etc.). The computer-readable storage media may also include additional removable storage and/or non-removable storage including, but not limited to, flash memory, magnetic storage, optical storage, and/or tape storage that may provide non-volatile storage of computer-readable instructions, data structures, program modules, and the like.

A non-transient or non-transitory computer-readable storage medium is an example of computer-readable media. Computer-readable media includes at least two types of computer-readable media, namely computer-readable storage media and communications media. Computer-readable storage media includes volatile and non-volatile, removable and non-removable media implemented in any process or technology for storage of information such as computer-readable instructions, data structures, program modules, or other data. Computer-readable storage media includes, but is not limited to, phase change memory (“PRAM”), static random-access memory (“SRAM”), dynamic random-access memory (“DRAM”), other types of random-access memory (“RAM”), read-only memory (“ROM”), electrically erasable programmable read-only memory (“EEPROM”), flash memory or other memory technology, compact disk read-only memory (“CD-ROM”), digital versatile disks (“DVD”) or other optical storage, magnetic cassettes, magnetic tape, magnetic disk storage or other magnetic storage devices, or any other non-transmission medium that can be used to store information for access by a computing device. In contrast, communication media may embody computer-readable instructions, data structures, program modules, or other data in a modulated data signal, such as a carrier wave, or other transmission mechanism. As defined herein, computer-readable storage media do not include communication media.

The computer-readable instructions stored on one or more non-transitory computer-readable storage media that, when executed by one or more processors, may perform operations described above with reference to FIGS. 1 to 6. Generally, computer-readable instructions include routines, programs, objects, components, data structures, and the like that perform particular functions or implement particular abstract data types. The order in which the operations are described is not intended to be construed as a limitation, and any number of the described operations can be combined in any order and/or in parallel to implement the processes.

FIG. 8 illustrates an example encoding and decoding computing system 800 for implementing the processes and methods described above for implementing intra template matching prediction mode.

The techniques and mechanisms described herein may be implemented by multiple instances of the encoding and decoding computing system 800 as well as by any other computing device, system, and/or environment. The system 800 shown in FIG. 8 is only one example of a system and is not intended to suggest any limitation as to the scope of use or functionality of any computing device utilized to perform the processes and/or procedures described above. Other well-known computing devices, systems, environments and/or configurations that may be suitable for use with the embodiments include, but are not limited to, personal computers, server computers, hand-held or laptop devices, multiprocessor systems, microprocessor-based systems, set top boxes, game consoles, programmable consumer electronics, network PCs, minicomputers, mainframe computers, distributed computing environments that include any of the above systems or devices, implementations using field programmable gate arrays (“FPGAs”) and application specific integrated circuits (“ASICs”), and/or the like.

The encoding and decoding computing system 800 may include one or more processors 802 and system memory 804 communicatively coupled to the processor(s) 802. The processor(s) 802 may execute one or more modules and/or processes to cause the encoding and decoding computing processor(s) 802 to perform a variety of functions. In some embodiments, the processor(s) 802 may include a central processing unit (“CPU”), a graphics processing unit (“GPU”), both CPU and GPU, or other processing units or components known in the art. Additionally, each of the processor(s) 802 may possess its own local memory, which also may store program modules, program data, and/or one or more operating systems.

Depending on the exact configuration and type of the encoding and decoding computing system 800, the system memory 804 may be volatile, such as RAM, non-volatile, such as ROM, flash memory, miniature hard drive, memory card, and the like, or some combination thereof. The system memory 804 may include one or more computer-executable modules 806 that are executable by the processor(s) 802.

The modules 806 may include, but are not limited to, one or more of an encoder 808 and a decoder 810.

The encoder 808 may be a VVC-standard encoder implementing any, some, or all aspects of example embodiments of the present disclosure as described above, and executable by the processor(s) 802 to configure the processor(s) 802 to perform operations as described above.

The decoder 810 may be a VVC-standard encoder implementing any, some, or all aspects of example embodiments of the present disclosure as described above, executable by the processor(s) 802 to configure the processor(s) 802 to perform operations as described above.

The encoding and decoding computing system 800 may additionally include an input/output (“I/O”) interface 840 for receiving image source data and bitstream data, and for outputting reconstructed pictures into a reference picture buffer and/or a display buffer. The encoding and decoding computing system 800 may also include a communication module 850 allowing the encoding and decoding computing system 800 to communicate with other devices (not shown) over a network (not shown). The network may include the Internet, wired media such as a wired network or direct-wired connections, and wireless media such as acoustic, radio frequency (“RF”), infrared, and other wireless media.

Some or all operations of the methods described above can be performed by execution of computer-readable instructions stored on a computer-readable storage medium, as defined below. The term “computer-readable instructions” as used in the description and claims, include routines, applications, application modules, program modules, programs, components, data structures, algorithms, and the like. Computer-readable instructions can be implemented on various system configurations, including single-processor or multiprocessor systems, minicomputers, mainframe computers, personal computers, hand-held computing devices, microprocessor-based, programmable consumer electronics, combinations thereof, and the like.

The computer-readable storage media may include volatile memory (such as random-access memory (“RAM”)) and/or non-volatile memory (such as read-only memory (“ROM”), flash memory, etc.). The computer-readable storage media may also include additional removable storage and/or non-removable storage including, but not limited to, flash memory, magnetic storage, optical storage, and/or tape storage that may provide non-volatile storage of computer-readable instructions, data structures, program modules, and the like.

A non-transient or non-transitory computer-readable storage medium is an example of computer-readable media. Computer-readable media includes at least two types of computer-readable media, namely computer-readable storage media and communications media. Computer-readable storage media includes volatile and non-volatile, removable and non-removable media implemented in any process or technology for storage of information such as computer-readable instructions, data structures, program modules, or other data. Computer-readable storage media includes, but is not limited to, phase change memory (“PRAM”), static random-access memory (“SRAM”), dynamic random-access memory (“DRAM”), other types of random-access memory (“RAM”), read-only memory (“ROM”), electrically erasable programmable read-only memory (“EEPROM”), flash memory or other memory technology, compact disk read-only memory (“CD-ROM”), digital versatile disks (“DVD”) or other optical storage, magnetic cassettes, magnetic tape, magnetic disk storage or other magnetic storage devices, or any other non-transmission medium that can be used to store information for access by a computing device. In contrast, communication media may embody computer-readable instructions, data structures, program modules, or other data in a modulated data signal, such as a carrier wave, or other transmission mechanism. A computer-readable storage medium employed herein shall not be interpreted as a transitory signal itself, such as a radio wave or other free-propagating electromagnetic wave, electromagnetic waves propagating through a waveguide or other transmission medium (such as light pulses through a fiber optic cable), or electrical signals propagating through a wire.

The computer-readable instructions stored on one or more non-transient or non-transitory computer-readable storage media that, when executed by one or more processors, may perform operations described above with reference to FIGS. 1 and 2. Generally, computer-readable instructions include routines, programs, objects, components, data structures, and the like that perform particular functions or implement particular abstract data types. The order in which the operations are described is not intended to be construed as a limitation, and any number of the described operations can be combined in any order and/or in parallel to implement the processes.

Although the subject matter has been described in language specific to structural features and/or methodological acts, it is to be understood that the subject matter defined in the appended claims is not necessarily limited to the specific features or acts described. Rather, the specific features and acts are disclosed as exemplary forms of implementing the claims.

What is claimed is:

1. A method comprising:
performing, by one or more processors of an input preprocessing computing system, a plurality of convolutions upon input picture data;
outputting, by the one or more processors, a plurality of intermediate feature maps from respective different convolutions;
averaging, by the one or more processors, absolute values of the plurality of intermediate feature maps to yield a fused feature map; and
resizing the fused feature map to a size of the input picture data.

2. The method of claim 1, further comprising performing, by the one or more processors, a Gaussian blurring transformation upon a pixel of the input picture data, the Gaussian blurring transformation taking as input a feature map value corresponding to the pixel from the fused feature map.

3. The method of claim 2, wherein the feature map value corresponding to the pixel is computed, by the one or more processors, as a standard deviation value in the Gaussian blur transformation.

4. The method of claim 2, wherein the one or more processors perform a Gaussian blurring transformation upon each pixel of the input picture data.

5. The method of claim 2, wherein the plurality of convolutions are performed by the one or more processors during segmentation computations performed upon the input picture data to output an object mask.

6. The method of claim 5, further comprising modifying, by the one or more processors, the object mask to exclude each pixel of a sliding window.

7. The method of claim 6, further comprising multiplying, by the one or more processors, the modified object mask and the input picture data to output block-based masked input picture data.

8. The method of claim 7, wherein the one or more processors perform a Gaussian blurring transformation upon the block-based masked input picture data.

9. The method of claim 8, further comprising deciding, by the one or more processors, based on average object mask ratio of a video sequence exceeding a threshold, to perform a Gaussian blurring transformation upon the block-based masked input picture data.

10. The method of claim 8, further comprising deciding, by the one or more processors, based on temporal complexity of a video sequence of a video sequence exceeding a threshold, to perform a Gaussian blurring transformation upon the block-based masked input picture data.

11. A computing system comprising:
one or more processors, and
a computer-readable storage medium communicatively coupled to the one or more processors, the computer-readable storage medium storing computer-readable instructions executable by the one or more processors that, when executed by the one or more processors, perform associated operations comprising:
performing a plurality of convolutions upon input picture data;
outputting a plurality of intermediate feature maps from respective different convolutions;
averaging absolute values of the plurality of intermediate feature maps to yield a fused feature map; and
resizing the fused feature map to a size of the input picture data.

12. The computing system of claim 11, wherein the one or more processors are further configured to blur input picture data by performing a Gaussian blurring transformation upon a pixel of the input picture data, the Gaussian blurring transformation taking as input a feature map value corresponding to the pixel from the fused feature map.

13. The computing system of claim 12, wherein the one or more processors are configured to compute the feature map value corresponding to the pixel as a standard deviation value in the Gaussian blur transformation.

14. The computing system of claim 12, wherein the one or more processors are configured to perform a Gaussian blurring transformation upon each pixel of the input picture data.

15. The computing system of claim 12, wherein the one or more processors are configured to perform the plurality of convolutions during segmentation computations performed upon the input picture data to output an object mask.

16. The computing system of claim 15, wherein the one or more processors are further configured to modify the object mask to exclude each pixel of a sliding window.

17. The computing system of claim 16, wherein the one or more processors are further configured to multiply the modified object mask and the input picture data to output block-based masked input picture data.

18. The computing system of claim 17, wherein the one or more processors are configured to perform a Gaussian blurring transformation upon the block-based masked input picture data.

19. The computing system of claim 18, wherein the one or more processors are further configured to decide, based on average object mask ratio of a video sequence exceeding a threshold, to perform a Gaussian blurring transformation upon the block-based masked input picture data.

20. The computing system of claim 18, wherein the one or more processors are further configured to decide, based on temporal complexity of a video sequence of a video sequence exceeding a threshold, to perform a Gaussian blurring transformation upon the block-based masked input picture data.
